(19) United States
(12) Patent Application Publication
(10) Pub. No.: US 2019/0225107 A1
(43) Pub. Date: Jul. 25, 2019

(54) RECHARGING SYSTEM, RECHARGING CONTROLLER, BATTERY CHARGER, INFORMATION DEVICE, RECHARGING METHOD, AND STORAGE MEDIUM

(71) Applicant: NEC Corporation, Minato-ku, Tokyo (JP)

(72) Inventors: Jun MORIZONO, Tokyo (JP); Tsuyoshi ABE, Tokyo (JP); Yasuaki KONDO, Tokyo (JP); Jiroh KUBOTA, Tokyo (JP)

(73) Assignee: NEC Corporation, Minato-ku, Tokyo (JP)

(21) Appl. No.: 16/336,149

(22) PCT Filed: Sep. 19, 2017
(86) PCT No.: PCT/JP2017/033670

§ 371 Date: Mar. 25, 2019

(30) Foreign Application Priority Data
Sep. 30, 2016 (JP) 2016-194473

(51) Int. Cl. B60L 53/66; B60L 53/67

(52) U.S. Cl. CPC B60L 53/66; B60K 6/28; B60L 53/67

(57) ABSTRACT

A recharging system according to one example embodiment of the present invention includes: a plurality of battery chargers each of which is capable of charging a battery of a vehicle and transmitting a control signal that instructs the vehicle to start recharging; and a recharging controller that controls the plurality of battery chargers. The recharging controller includes a communication unit capable of communicating with the vehicle, sequentially outputs identification signals indicating instruction other than start of recharging from the plurality of battery chargers, respectively, and when receiving a response signal from the vehicle responding to the identification signals via the communication unit, allows the vehicle which has transmitted the response signal to perform recharging.

### TECHNICAL FIELD

The present invention relates to a recharging system, a recharging controller, a battery charger, an information device, a recharging method, and a storage medium for electric motor vehicles.

### BACKGROUND ART

Due to increase of environmental interest, hybrid electric vehicles (HEV) and plug-in hybrid electric vehicles (PHE) in which both an electric motor and an engine are used have become popular. Furthermore, in recent years, electric vehicles (EV) driven by an electric motor only have been developed.

To facilitate widespread use of electric motor vehicles, enhancement of a recharging system that charges a battery is indispensable, various recharging systems have been proposed. For example, a recharging system disclosed in Patent Literature 1 includes a plurality of battery chargers that can be connected to a vehicle, a recharging controller that manages a plurality of battery chargers, and a server connected to a network. The battery charger is typically provided in a parking lot of a shopping mall or the like, and the recharging controller may be installed at the entrance of the shop. In such a recharging system, a user is required to connect the battery charger to the vehicle by a connector cable and then operate the recharging controller to start recharging. That is, the user causes the recharging controller to read an ID card and enters the number of the battery charger connected to the vehicle, and thereby the recharging controller starts charging with the designated battery charger.

### CITATION LIST

### Patent Literature

PTL 1: Japanese Patent Application Laid-Open No. 2015-186338

### SUMMARY OF INVENTION

In the recharging system disclosed in Patent Literature 1, the user has to perform a complex operation to cause the recharging controller to read the ID card, enter a battery charger number, and the like. Further, when the recharging controller is installed distant from the battery charger, the user has to get off the vehicle and then move on foot to the recharging controller. In particular, when the recharging system is provided in a large parking lot, the distance from the battery charger to the recharging controller tends to be long, and the burden on the user becomes larger.

Here, it may be possible to automatically detect which battery charger the authenticated vehicle is connected to and thereby eliminate the need of the user operation on recharging controller. However, the recharge standard for electric vehicles is strictly defined, and thus the battery charger is not allowed to communicate data for authenticating a vehicle via a charging cable.

The present invention has been made in view of the above problem and intends to provide a recharging system, a recharging controller, a battery charger, a mobile terminal, a recharging method, and a program that can start detecting which battery charger a vehicle is connected to without changing the conventional recharge standard.

According to one example aspect of the present invention, provided is a recharging system including: a plurality of battery chargers each of which is capable of charging a battery of a vehicle and transmitting a control signal that instructs the vehicle to start recharging; and a recharging controller that controls the plurality of battery chargers. The recharging controller includes a communication unit capable of communicating with the vehicle, sequentially outputs identification signals indicating instruction other than start of recharging from the plurality of battery chargers, respectively, and when receiving a response signal from the vehicle responding to the identification signals via the communication unit, allows the vehicle which has transmitted the response signal to perform recharging.

According to another example aspect of the present invention, provided is a recharging controller that controls a plurality of battery chargers each of which is capable of charging a battery of a vehicle and transmitting a control signal that instructs the vehicle to start recharging. The recharging controller includes a communication unit capable of communicating with the vehicle, sequentially outputs identification signals indicating instruction other than start of recharging from the plurality of battery chargers, respectively, and when receiving a response signal from the vehicle responding to the identification signals via the communication unit, allows the vehicle which has transmitted the response signal to perform recharging.

According to another example aspect of the present invention, provided is a battery charger that is capable of charging a battery of a vehicle and transmitting a control signal that instructs the vehicle to start recharging. The battery charger sequentially outputs an identification signal indicating instruction other than start of recharging by being controlled by a recharging controller including a communication unit capable of communicating with the vehicle, and when the recharging controller receives a response signal from the vehicle responding to the identification signal via the communication unit, allows the vehicle which has transmitted the response signal to perform recharging.

According to another example aspect of the present invention, provided is an information device used in a recharging system including a plurality of battery chargers each of which is capable of charging a battery of a vehicle and transmitting a control signal that instructs the vehicle to start recharging and a recharging controller that controls the plurality of battery chargers. The information device includes: an input unit that receives from the vehicle a notification that an identification signal indicating an instruction other than start of recharging is output; and a communication unit that transmits a response signal to the identification signal to the recharging controller. When the recharging controller receives the response signal via a communication unit, the input unit receives a notification that the vehicle which has transmitted the response signal is allowed to perform recharging.

According to another example aspect of the present invention, provided is a recharging method for a recharging system including a plurality of battery chargers each of which is capable of charging a battery of a vehicle and transmitting a control signal that instructs the vehicle to start recharging and a recharging controller that controls the plurality of battery chargers. The recharging method includes steps of: sequentially outputting identification signals indicating instruction other than start of recharging from the plurality of battery chargers, respectively; and when the recharging controller receives a response signal from the vehicle responding to the identification signals via a communication unit, allowing the vehicle which has transmitted the response signal to perform recharging.

According to another example aspect of the present invention, provided is a storage medium storing a program that causes a computer to execute a recharging method for a recharging system comprising a plurality of battery chargers each of which is capable of charging a battery of a vehicle and transmitting a control signal that instructs the vehicle to start recharging and a recharging controller that controls the plurality of battery chargers. The recharging method includes steps of: sequentially outputting identification signals indicating instruction other than start of recharging from the plurality of battery chargers, respectively; and when receiving a response signal from the vehicle responding to the identification signals, allowing the vehicle which has transmitted the response signal to perform recharging.

### Advantageous Effects of Invention

According to the present invention, it is possible to detect which battery charger a vehicle is connected to and start recharging without changing the conventional recharge standard.

### BRIEF DESCRIPTION OF DRAWINGS

FIG. 1 is a block diagram of a recharging system of an electric motor vehicle in a first example embodiment.

FIG. 2 is a block diagram of a recharging controller in the first example embodiment.

FIG. 3 is a block diagram of a battery charger in the first example embodiment.

FIG. 4 is a block diagram of a charging circuit of a vehicle in the first example embodiment.

FIG. 5 is a chart illustrating a pilot signal CPLT in the first example embodiment.

FIG. 6 is a sequence chart representing a user registration process in the first example embodiment.

FIG. 7 is a sequence chart of a recharging system in the first example embodiment.

FIG. 8 is a sequence chart of the recharging system in the first example embodiment.

FIG. 9 is a sequence chart of the recharging system in the first example embodiment.

FIG. 10 is a block diagram of a charging circuit of a vehicle and a mobile terminal in a second example embodiment.

FIG. 11 is a sequence chart of a recharging system in the second example embodiment.

FIG. 12 is a sequence chart of the recharging system in the second example embodiment.

FIG. 13 is a block diagram of a recharging system of an electric motor vehicle in a third example embodiment.

### DESCRIPTION OF EMBODIMENTS

Example embodiments of the present invention will be described below with reference to the drawings.

### First Example Embodiment

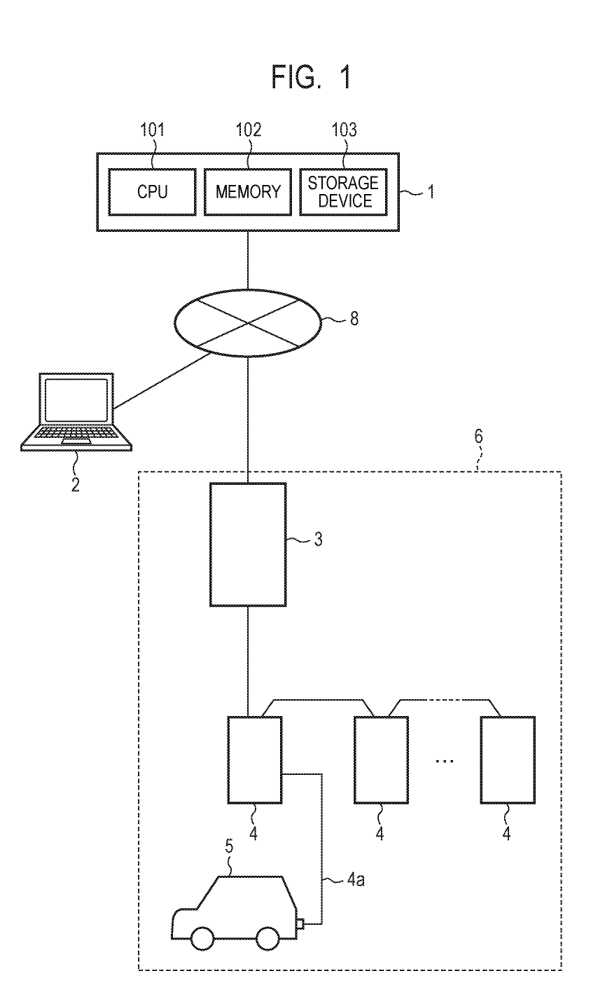

FIG. 1 is a block diagram of a recharging system of an electric motor vehicle in the present example embodiment. The recharging system includes a server 1, a recharging controller 3, and a plurality of battery chargers 4. The server 1 is a so-called cloud server and is connected to a user terminal 2 and the recharging controller 3 via a network 8. While only the single user terminal 2 and the single recharging controller 3 are illustrated in FIG. 1, a plurality of user terminals 2 or a plurality of recharging controllers 3 may be connected to the server 1. The server 1 includes a CPU 101, a memory 102, and a storage device 103 and may perform not only storage and management of registration information, payment information, recharging history, or the like on users but also management of the recharging controller 3 and the battery chargers 4.

The user terminal 2 may be a computer arranged in a user's house or a mobile phone such as a smartphone. The user is able to enter and confirm registration information or payment information by connecting the user terminal 2 to the server 1. The recharging controller 3 and the battery chargers 4 are provided in a parking lot of a shopping mall or the like, a charging station in a town, or the like. The recharging controller 3 is installed near the entrance of a facility having a parking lot 6, for example, and each of the battery chargers 4 is provided near a parking space for each vehicle. The plurality of battery chargers 4 are connected to the recharging controller 3 in a cascade manner by serial communication. While the number of battery chargers 4 may be over several thousands, this does not exclude the number being one. Each of the battery chargers 4 has a charging cable 4a, and when the charging cable 4a is connected to a vehicle 5, a current is supplied from the battery charger 4 to a battery of the vehicle 5. While the battery charger 4 is typically a normal battery charger, the battery charger 4 may be a quick battery charger. The vehicle 5 is an electric motor vehicle such as a hybrid electric vehicle (HEV) or a plug-in hybrid electric vehicle (PHE) in which both an electric motor and an engine are used or an electric vehicle (EV) driven by an electric motor only. In the description below, these electric motor vehicles will be simply referred to as a “vehicle”.

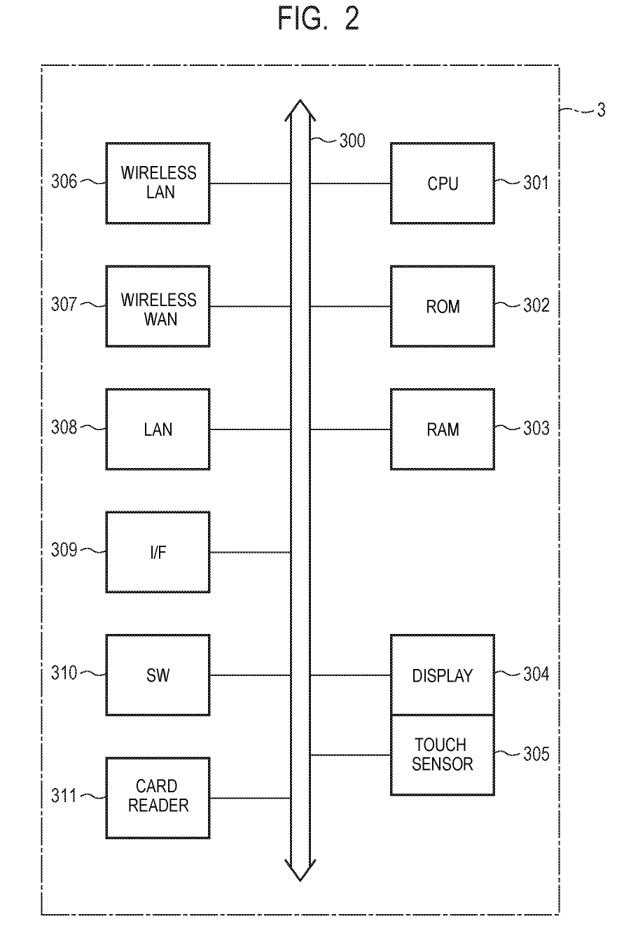

FIG. 2 is a block diagram of a recharging controller 3 in the present example embodiment. The recharging controller 3 includes a bus 300, a CPU 301, a read-only memory (ROM) 302, a random access memory (RAM) 303, a display 304, a touch sensor 305, a wireless local area network (LAN) unit 306, a wireless wide area network (WAN) unit 307, a LAN unit 308, an interface (I/F) 309, a switch (SW) 310, and a card reader 311.

The CPU 301 executes a recharge process in accordance with a predefined application program. The application program may be written in the ROM 302 or may be downloaded from the server 1 via the network 8. The RAM 303 provides a memory region necessary for the operation of the CPU 301. The display 304 is a touchscreen on which the touch sensor 305 is arranged on the surface thereof. A number provided to the battery charger 4, a recharge level, a billing amount, or the like may be displayed on the display 304. The wireless LAN unit 306 is a wireless transceiver unit based on the Wi-Fi standard, for example. It is desirable that the transmittable area of the wireless LAN unit 306 cover the entire parking lot, that is, the region where the recharging controller 3 and the battery chargers 4 are provided. The wireless WAN unit 307 is a transceiver unit capable of connecting to a public wireless line such as 3G, LTE, 4G, or the like and wirelessly communicates with a base station (not illustrated). The wireless LAN unit 306 and the wireless WAN unit 307 are used for communication with a vehicle. Note that, when the parking lot is relatively narrow, near-field communication such as Bluetooth (registered trademark) may be used.

The I/F 309 is an interface unit based on a serial communication standard such as RS232C, RS485, or the like and is able to communicate with the plurality of battery chargers 4 connected in a cascade manner. The card reader 311 is a device that reads information such as a member's card, an electronic money card, or the like, which may be a contact-type or a contactless type.

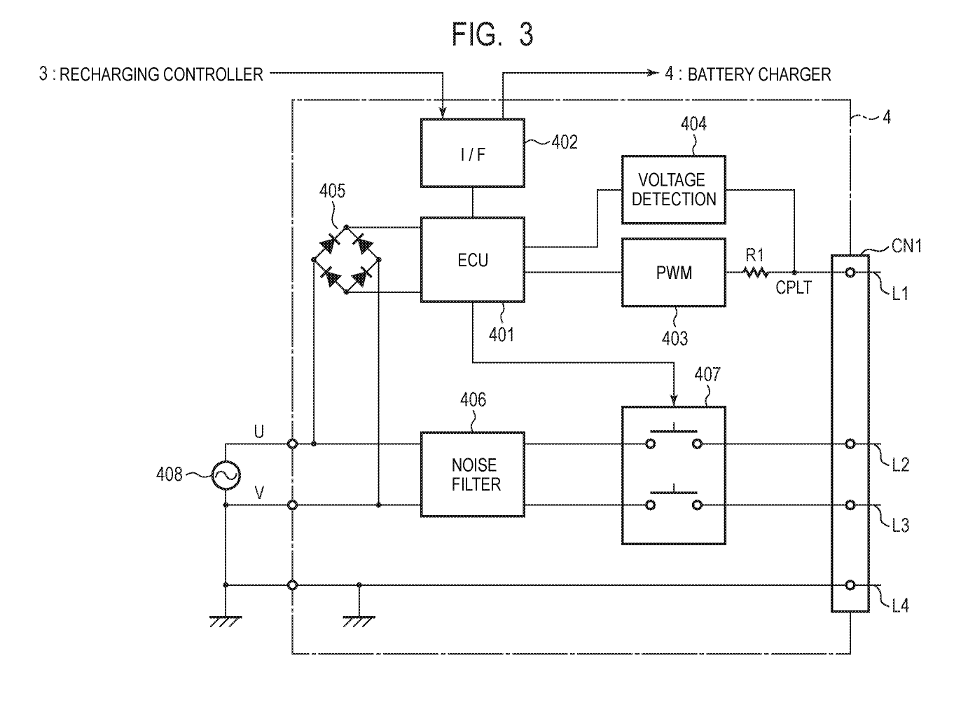

FIG. 3 is a block diagram of the battery charger 4 in the present example embodiment. The battery charger 4 includes an ECU 401, an I/F 402, a pulse width modulation (PWM) circuit 403, a voltage detection circuit 404, a rectifier circuit 405, a noise filter 406, a relay switch 407, and a connector CN1. The ECU 401 is formed of a CPU, a memory device, and the like and executes a recharge process in accordance with a predefined application program. The application program may be written in a memory in advance or may be downloaded from a network. The I/F 402 is a serial communication interface unit according to RS223C, RS485, or the like and may be connected to the recharging controller 3 and other battery chargers 4.

The PWM circuit 403 includes an oscillation circuit, a pulse width modulation circuit, and a voltage control circuit and outputs a pilot signal Control Pilot (CPLT) based on the standard of SAE Electric Vehicle Conductive Charge Couple, SAE J1722, IEC6185. As described later, the pilot signal CPLT is a control signal that represents start and end of recharging, an instruction of a current amount, a connection state of a charging cable, or the like by changing the voltage and the pulse width thereof. The output terminal of the PWM circuit 403 is connected to the connector CN1 via the resistor R1. The voltage detection circuit 404 is formed of a voltage comparator circuit or the like and detects the voltage of the pilot signal CPLT.

The rectifier circuit 405 includes a diode-bridge circuit, converts an alternating current supplied from an AC power source 408 into a direct current, and supplies a power source voltage to the ECU 401, the I/F 402, the PWM circuit 403, and the voltage detection circuit 404. Although not illustrated, the rectifier circuit 405 may include a smoothing circuit such as an inductor, a capacitor, or the like. A noise filter 406 is a filter circuit that removes a surge noise or the like included in the AC power source 408. The relay switch 407 has an electromagnetic solenoid and a moving contact and causes an electric path between the AC power source 408 and the connector CN1 to be opened or closed in accordance with a control signal from the ECU 401. The connector CN1 is connected to the charging cable 4a, and the charging cable 4a includes a control signal line L1, power source lines L2 and L3, and a ground line L4.

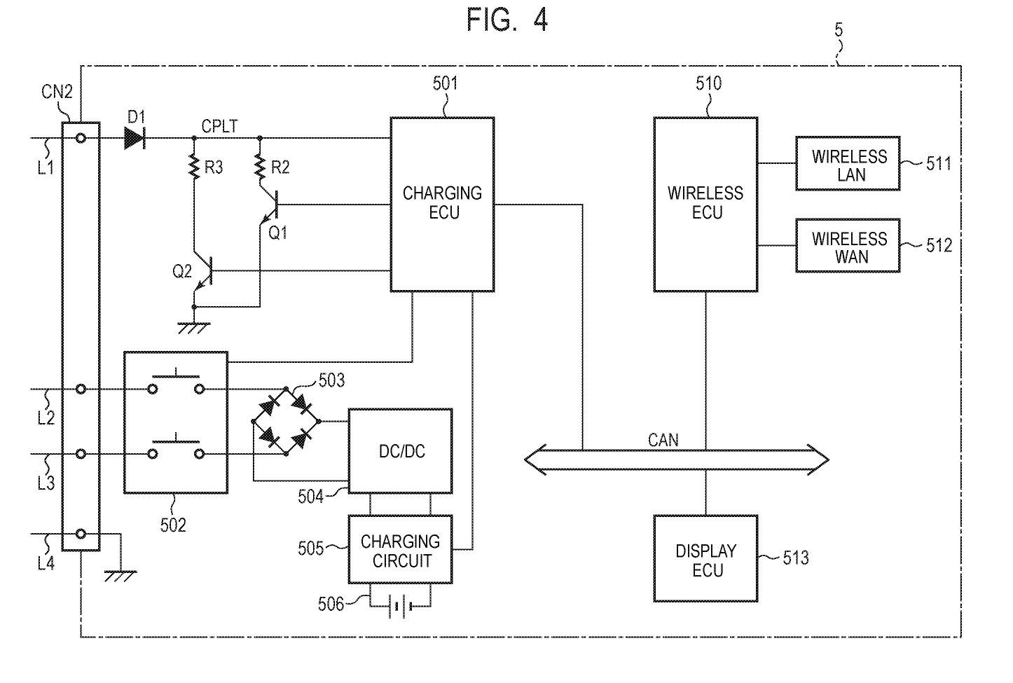

FIG. 4 is a block diagram of a charging circuit of the vehicle 5 in the present example embodiment. The charging circuit of the vehicle 5 includes a charging ECU 501, a relay switch 502, a rectifier circuit 503, a DC/DC converter 504, a charging circuit 505, a battery 506, a wireless ECU 510, a wireless LAN unit 511, a wireless WAN unit 512, a display ECU 513, and a connector CN2. The plug of the charging cable 4a is connected to the connector CN2, which forms electrical paths to the control signal line L1, the power source lines L2 and L3, the ground line L4, and the vehicle 5. The charging ECU 501 includes a CPU, a memory, an analog-to-digital converter, and the like and executes a process according to a predefined application program. A CPLT signal is input to the input terminal of the charging ECU 501 from the connector CN2 and a diode D1 via the control signal line L1. Each one end of resistors R2 and R3 is connected to the control signal line L1. The other end of the resistor R2 is connected to the collector of a transistor switch Q1, and the emitter thereof is grounded. Further, the other end of the transistor 3 is connected to the collector of a transistor switch Q2, and the emitter thereof is grounded. The control signal is input to the gates of the transistor switches Q1 and Q2 from the charging ECU, a high level voltage is applied to the gates, and thereby the transistor switches Q1 and Q2 are turned on.

When the transistor switches Q1 and Q2 are turned off, a voltage resulted by subtracting the forward voltage of the diode D1 (around 0.7 V) from the voltage of the CPLT signal occurs on the control signal line L1. Further, when the transistor switch Q1 is turned on, a voltage resulted by multiplying the voltage of the pilot signal CPLT by the ratio R2/(R1+R2) occurs on the control signal line L1. Furthermore, when both the transistor switches Q1 and Q2 are turned on, a voltage resulted by multiplying the voltage of the pilot signal CPLT by the ratio (R2×R3/(R2+R3))/(R1+(R2×R3/(R2+R3))) occurs. As discussed above, by the charging ECU 501 turning on and off the transistor switches Q1 and Q2, it is possible to change the voltage of the CPLT signal. The voltage change of the pilot signal CPLT may be detected in the charging ECU 501 and the voltage detection circuit 404 of the battery charger 4, respectively.

The relay switch 502 is controlled by the charging ECU 501 to open and close the electrical path between the connector CN2 and the rectifier circuit 503. The rectifier circuit 503 converts an alternating current into a direct current and supplies a DC current to the DC/DC converter 504. The DC/D converter 504 steps up the rectified DC voltage to a voltage necessary for charging the battery 506. The charging circuit 505 has a circuit that controls a current supplied to the battery 506, a protection circuit, and the like. By supplying a current from the charging circuit 505 to the battery 506, the battery 506 is charged.

The wireless ECU 510 has a CPU, a memory, and the like and is connected to the charging ECU 501 via a Control Area Network (CAN). The wireless LAN unit 511 and the wireless WAN unit 512 can wirelessly communicate with the recharging controller 3 and are controlled by the wireless ECU 510. The display ECU 513 controls a display such as an instrumental panel of the vehicle and displays a state of connection to the battery charger 4, a state of recharging, or the like on the display.

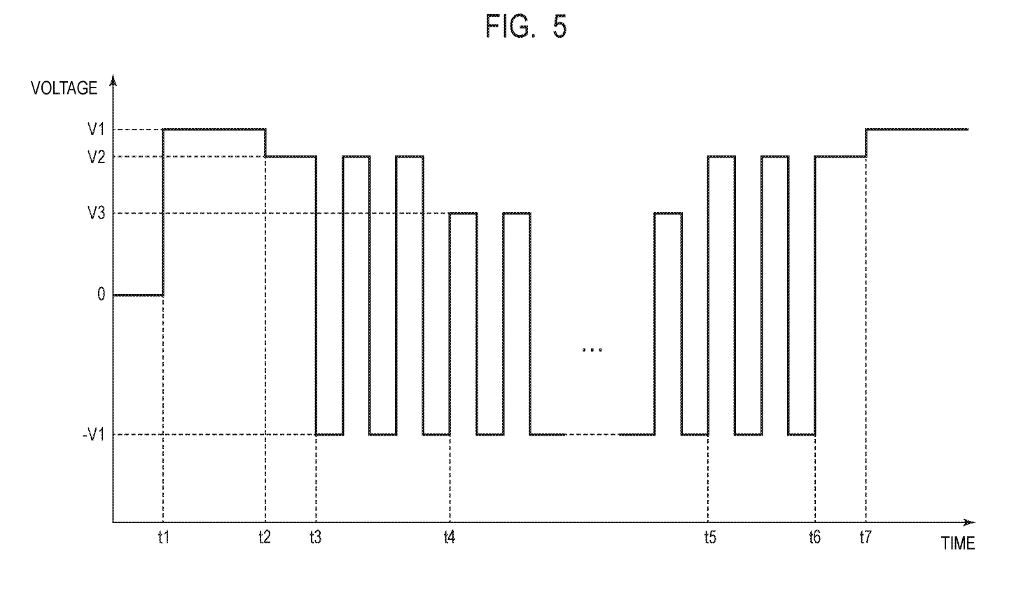

FIG. 5 is a chart illustrating the CPLT signal. In FIG. 5, the horizontal axis represents time, and the vertical axis represents a voltage of the pilot signal CPLT detected by the voltage detection circuit 404. At time t1, the battery charger 4 is powered on, and the PWM circuit 403 outputs a voltage V1 (for example, 12 V). At this time, the charging cable 4a of the battery charger 4 is not connected to the vehicle 5. Further, in the vehicle 5, the transistor switch Q1 has been turned on. At time t2, in response to the charging cable 4a being connected to the vehicle 5, the voltage of the pilot signal CPLT becomes a voltage V2 (for example 9 V) that is reduced by the division ratio of the resistors R1 and R2. At time t3, the PWM circuit 403 starts oscillation and outputs an AC signal (for example 1 kHz) having a predetermined duty ratio. By changing the duty ratio, it is possible to notify the charging ECU 501 in the vehicle 5 of the maximum transmittable current value.

At time t4, the charging ECU 501 turns on the transistor switch Q2, and the voltage of the pilot signal CPLT further decreases to V3 (for example 6 V). The ECU 401 of the battery charger 4 turns on the relay switch 407 and supplies a charge current from the charging cable 4a to the vehicle 5. The charging ECU 501 of the vehicle 5 turns on the relay switch 502 and supplies a charge current to the battery 506, and recharging is started.

At time t5, upon the completion of recharging in the vehicle 5, the charging ECU 501 turns off the transistor switch Q2 to cause the voltage of the pilot signal CPLT to V2. Further, the charging ECU 501 turns off the relay switch 502. At the time t6, in response to detecting that the voltage of the pilot signal CPLT has increased to V2, the ECU 401 of the battery charger 4 turns off the relay switch 407 to stop supplying the charge current.

At time t7, when the user removes the charging cable 4a from the vehicle 5, the connector CN1 of the battery charger 4 is opened, and the voltage of the pilot signal CPLT increases to V1. By monitoring the voltage of the pilot signal CPLT, the ECU 401 can detect the removal of the charging cable 4a.

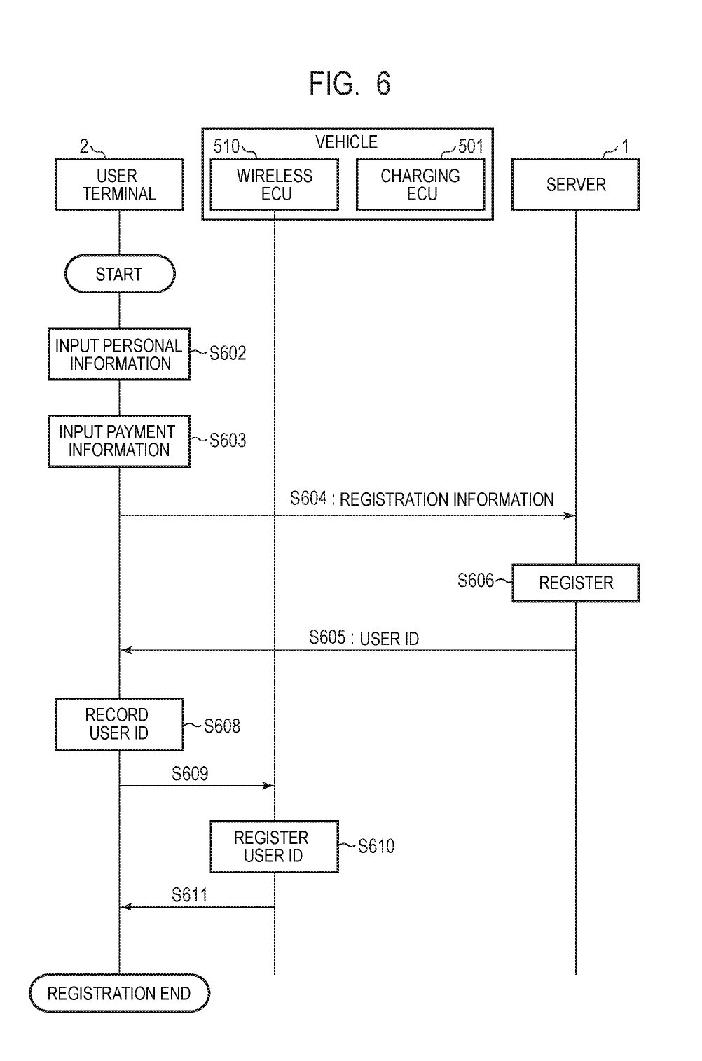

FIG. 6 is a sequence chart representing a user registration process in the present example embodiment. First, the user accesses the server 1 from the user terminal 2 and causes the user terminal 2 to display a website provided for user registration. The user fills in a user registration form with personal information such as a name, a contact address, or the like (step S602). Further, the user inputs payment information such as a credit card number or the like (step S603). The personal information and the payment information are transmitted from the user terminal 2 to the server 1 as registration information (step S604), and the server 1 registers the registration information to the database (step S606). The server 1 issues a user ID and notifies the user terminal 2 of the user ID (step S605). The user records the notified user ID in the user terminal 2 (step S608) and transmits the user ID to the vehicle 5 via a wireless LAN or a wireless WAN (step S609). The wireless ECU 510 of the vehicle 5 registers the user ID to the memory (step S610) and notifies the user terminal 2 of the completion of registration (step S611). As set forth, registration of the user ID is completed.

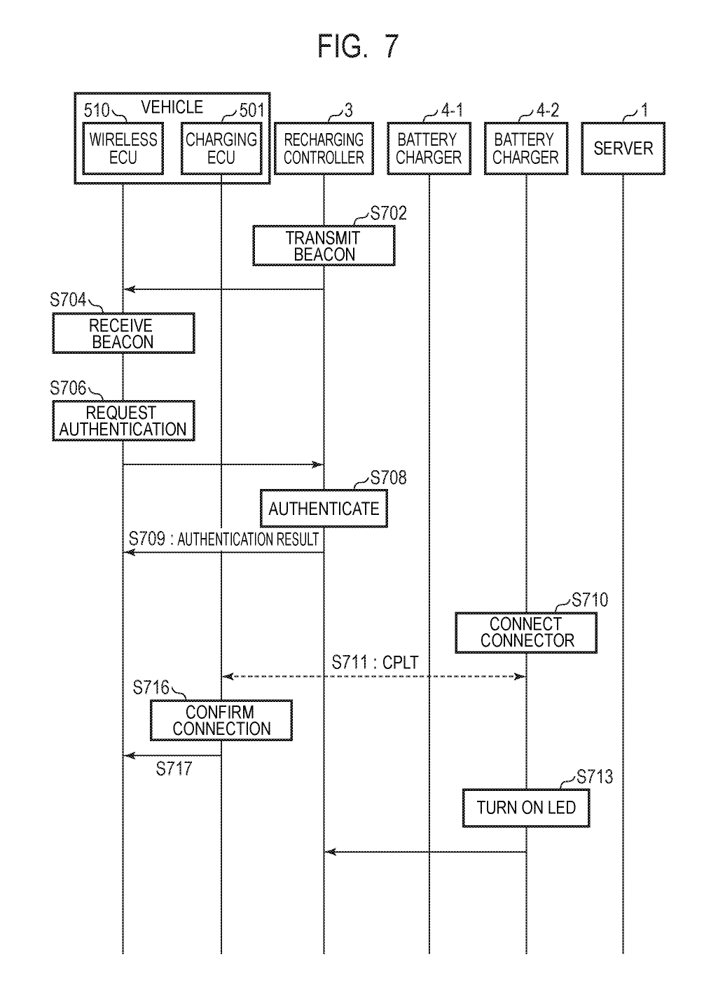

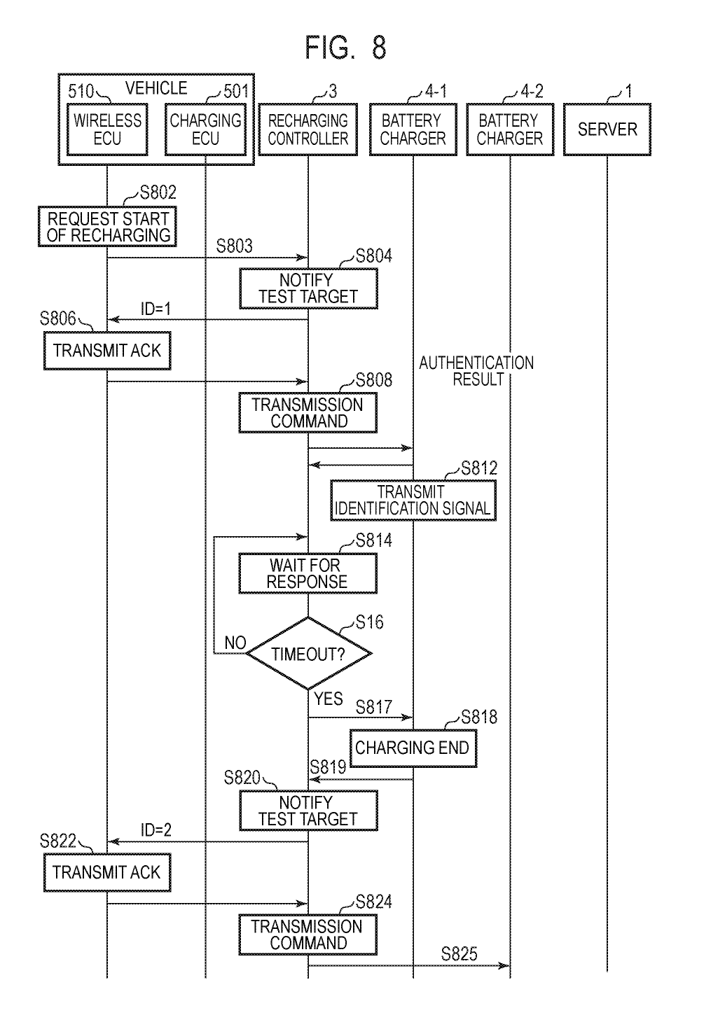

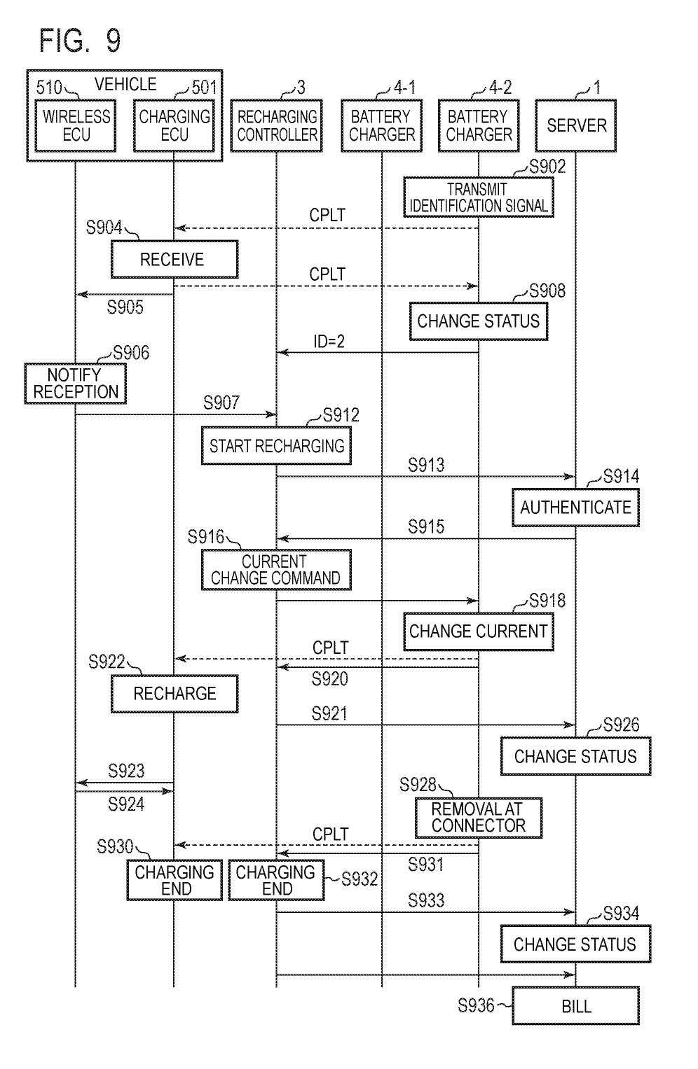

FIG. 7, FIG. 8, and FIG. 9 are sequence charts of the recharging system in the present example embodiment. The recharging controller 3 continues to transmit a beacon at a constant cycle (for example, 100 msec) from the wireless LAN unit 306 (step S702). The beacon includes a Service Set ID (SSID), channel (frequency) information, security information, or the like. When the vehicle 5 enters a parking lot, that is, a transmittable area of the wireless LAN unit 306, the wireless ECU 510 receives a beacon (step S704). The wireless ECU 510 determines whether or not the SSID included in the beacon matches the SSID held in the wireless ECU 510 and, if matched, transmits an authentication request including authentication information such as a password to the recharging controller 3 (step S706). The recharging controller 3 performs authentication based on the authentication request (step S708) and transmits an authentication result to the charging ECU 501 (step S709). In the vehicle 5, upon receiving the authentication result, the wireless ECU 510 causes the display ECU 513 to display that recharging is available.

The user stops the vehicle 5 in front of the battery charger 4-2 and connects the charging cable 4a to the connector CN2 of the vehicle 5 (step S710). In the battery charger 4-2, due to the connection of the charging cable 4a to the vehicle 5, the voltage of the pilot signal CPLT decreases from 12 V to 9 V (step S711). In response to detecting that the voltage of the pilot signal CPLT becomes 9 V, the battery charger 4-2 determines that the charging cable 4a is connected to the vehicle 5 and turns on an LED (step S716). Furthermore, the battery charger 4-2 notifies the recharging controller 3 of the completion of connection of the vehicle 5 to the battery charger 4-2 together with the identification number (ID=2) of the battery charger 4-2.

On the other hand, in the vehicle 5, in response to detecting the pilot signal CPLT (step S711), the charging ECU 501 determines that the charging cable 4a has been connected (step S716). Furthermore, the charging ECU 501 notifies the wireless ECU 510 that the charging cable 4a has been connected (step S717).

In FIG. 8, the wireless ECU 510 transmits a recharge start request to the recharging controller 3 (step S802). In response to receiving the recharge start request, the recharging controller 3 sequentially transmits a detection signal to the battery chargers 4 connected to the vehicle 5. In the description below, it is assumed that different vehicles 5 are connected to the battery chargers 4-1 and 4-2, respectively, and a recharge start request is issued from the vehicle 5 connected to the battery charger 4-2. That is, at this time, the recharging controller 3 recognizes that vehicles 5 have been connected to the battery chargers 4-1 and 4-2, respectively, but does not recognize which of the battery chargers 4 the vehicle 5 which has issued the recharge start request is connected to. In the present example embodiment, the recharging controller 3 sequentially detects and scans the battery chargers 4 and detects the battery charger 4-2 connected to the vehicle 5 in accordance with the following procedure. Note that, in the description below, the vehicle 5 connected to the battery charger 4-1 is referred to as “another vehicle 5”.

First, in response to receiving the recharge start request (step S803), the recharging controller 3 notifies the wireless ECU 510 of the identification number (ID=1) of the battery charger 4 which is a test target out of the battery chargers 4 connected to the vehicles 5 (step S804). In this example, since the test target is the battery charger 4-1, the identification number is ID=1. In response to receiving the identification number (ID=1), the wireless ECU 510 of the vehicle 5 notifies the recharging controller 3 of an acknowledgement (step S806). Note that the recharging controller 3 may simply notify the wireless ECU 510 of the start of a test without notification of the identification number of the battery charger 4. The recharging controller 3 transmits a transmission command of an identification signal to the battery charger 4-1 (step S808). The battery charger 4-1 notifies the recharging controller 3 of an acknowledgement of the transmission command and transmits the pilot signal CPLT used for identification to another vehicle 5 in accordance with the transmission command (step S812). Here, the pilot signal CPLT used for identification is a signal other than is used for starting recharging, for example, a signal indicating that the maximum transmittable current is zero, that is, a signal whose duty ratio is the minimum. The recharging controller 3 waits for the notification that another vehicle 5 has received the pilot signal CPLT used for identification for a predetermined period (step S814, step S816, NO). The vehicle 5 connected to the battery charger 4-1 has not issued a recharge start request by a wireless LAN and thus does not transmit a reception notification to the recharging controller 3. If the recharging controller 3 does not receive a reception notification within a predetermined period (step S816, YES), the recharging controller 3 transmits a recharge end command to the battery charger 4-1 (step S817). The battery charger 4-1 ends the recharge operation (step S818) and notifies the recharging controller 3 of the end of recharge operation (step S819).

Subsequently, the recharging controller 3 notifies the wireless ECU 510 in the vehicle 5 of the identification number (ID=2) of the battery charger 4-2 which is the test target (step S820). The wireless ECU 510 of the vehicle 5 transmits an acknowledgement of the identification number to the recharging controller 3 (step S822). The recharging controller 3 transmits a transmission command of the identification signal to the battery charger 4-2 (step S824), and the battery charger 4-2 receives the transmission command (step S825).

In FIG. 9, the battery charger 4-2 transmits the pilot signal CPLT used for identification to the charging ECU 501 of the vehicle 5 (step S902). That is, the battery charger 4-2 minimizes the duty ratio of the pilot signal CPLT and transmits, to the charging ECU 501, a pilot signal CPLT indicating that the maximum transmittable current is zero. The charging ECU 501 receives the pilot signal CPLT and detects an identification signal based on the duty ratio of the pilot signal CPLT (step S904). In response to detecting the identification signal in the pilot signal CPLT, the charging ECU 501 notifies the wireless ECU 510 that the identification signal has been received (step S905). The wireless ECU 510 transmits a response signal indicating that the identification signal has been received to the recharging controller 3 via the wireless LAN unit 511 (step S906). The response signal includes the user ID and the battery charger ID (step S907). By transmitting the battery charger ID to the recharging controller 3, it is possible to avoid erroneous detection of the vehicle 5 connected to another battery charger 4. In such a way, the recharging controller 3 can correctly detect that the authenticated vehicle 5 is connected to the battery charger 4-2.

Further, when the charging ECU 501 receives the identification signal (step S904), the charging ECU 501 turns on the transistor switch Q2 and reduces the voltage of the pilot signal CPLT from 9 V to 6 V. As described above, the pilot signal CPLT of 6 V indicates the end of recharging. Since recharging with the maximum current being zero has been instructed to the vehicle 5, however, recharging of the vehicle 5 has not been performed. In response to detecting the voltage of the pilot signal CPLT, the battery charger 4-2 changes a battery charger status and enters a state of waiting for a recharge start command (step S908). Furthermore, the battery charger 4-2 transmits the identification number (ID=2) of the battery charger 4-2 to the recharging controller 3, the recharging controller 3 determines that recharging can be started at the battery charger 4-2 (step S912). The recharging controller 3 transmits the user ID of the vehicle 5 and the identification number of the battery charger 4-2 (ID=2) to the server 1 (step S913). The server 1 performs authentication of the user ID (step S914) and transmits an authentication result to the recharging controller 3 (step S915).

When the authentication is successful, the recharging controller 3 transmits a current change command to the battery charger 4-2 (step S916), and the battery charger 4-2 changes the maximum current from 0 A to 15 A, for example (step S918). The maximum current is determined by the duty ratio of the pilot signal CPLT as described above. The charging ECU 501 detects the duty ratio of the pilot signal CPLT and starts recharging at the predetermined maximum current (step S922). That is, the charging ECU 501 turns on the relay switch 502 and charges the current supplied from the battery charger 4-2 to the battery 506 (step S922). The charging ECU 501 notifies the wireless ECU 510 that recharging is ongoing (step S923), and the wireless ECU 510 sends back the confirmation of the notification (step S924).

The battery charger 4-2 notifies the recharging controller 3 that the maximum current has changed to 15 A (step S920), and the recharging controller 3 notifies the server 1 that recharging at the maximum current 15 A is started at the battery charger 4-2 (step S921). The server 1 records as a status that recharging at the user ID is started (step S926).

Upon the completion of recharging at the vehicle 5, the user removes the charging cable 4a from the vehicle 5 (step S928). In the vehicle 5, the pilot signal CPLT becomes a low level, and charging ECU 501 can detect that the charging cable 4a has been removed (step S930). In the battery charger 4-2, the pilot signal CPLT becomes 12 V, the battery charger 4-2 can detect that the charging cable 4a has been removed. The battery charger 4-2 notifies the recharging controller 3 that the charging cable 4a has been removed and the recharging has ended (step S931). In response to receiving the end of recharging at the battery charger 4-2 (step S932), the recharging controller 3 transmits a notification of the end of recharging together with the identification number (ID=2) of the battery charger 4-2 to the server 1 (step S933). The server 1 changes the states from “charging” to “charged” (step S934). Furthermore, the recharging controller 3 transmits the user ID, the identification number of the battery charger 4-2, the recharging time period, the recharging start/end time, the electric energy, or the like to the server 1 as billing information, and the server 1 performs a billing process on the user account (step S936).

As discussed above, according to the present example embodiment, it is possible to automatically detect which of the battery chargers 4 the vehicle 5 authenticated through a wireless LAN is connected to and starts recharging without changing the conventional recharge standard. Thereby, the user is not required to leave the vehicle 5 and operate the recharging controller 3, and the burden on the user can be reduced.

Note that the identification signal may be a different signal as long as it does not cause start of recharging. For example, a signal indicating a suspension state of recharging, that is, a signal indicating a state where the charging cable 4a is temporarily disconnected from the connector CN2 of the vehicle and the control signal line L1 is opened may be used as an identification signal. When the charging cable 4a is disconnected from the vehicle 5, no voltage is applied to the control signal line L1 from the battery charger 4, the control signal line L1 in the vehicle 5 becomes a ground potential or −12 V due to the resistor R2. Thus, the battery charger 4 uses a transistor switch or a relay switch to turns the control signal line L1 to an open (high impedance) state, and thereby the control signal line L1 in the vehicle 5 enters the same state as a state where the charging cable 4a is disconnected from the connector CN2. Thereby, the vehicle 5 can detect an identification signal of a state where the control signal line L1 is opened and transmit the response signal to the recharging controller 3.

Further, while the recharging controller 3 transmits identification signals sequentially to the respective battery chargers 4 as detection targets to which the vehicle 5 is connected in the present example embodiment, all the battery chargers 4 may be detection targets regardless of whether or not the vehicle 5 is connected. Further, the battery charger 4 which has completed recharging of the vehicle 5 may be excluded from the detection targets. Furthermore, while an example in which a plurality of authenticated vehicles 5 are connected to the plurality of battery chargers 4, respectively, has been illustrated in the above description, the same detection process may be performed to ensure the connection confirmation even when the authenticated vehicle 5 is connected to only one of the plurality of battery chargers 4.

### Second Example Embodiment

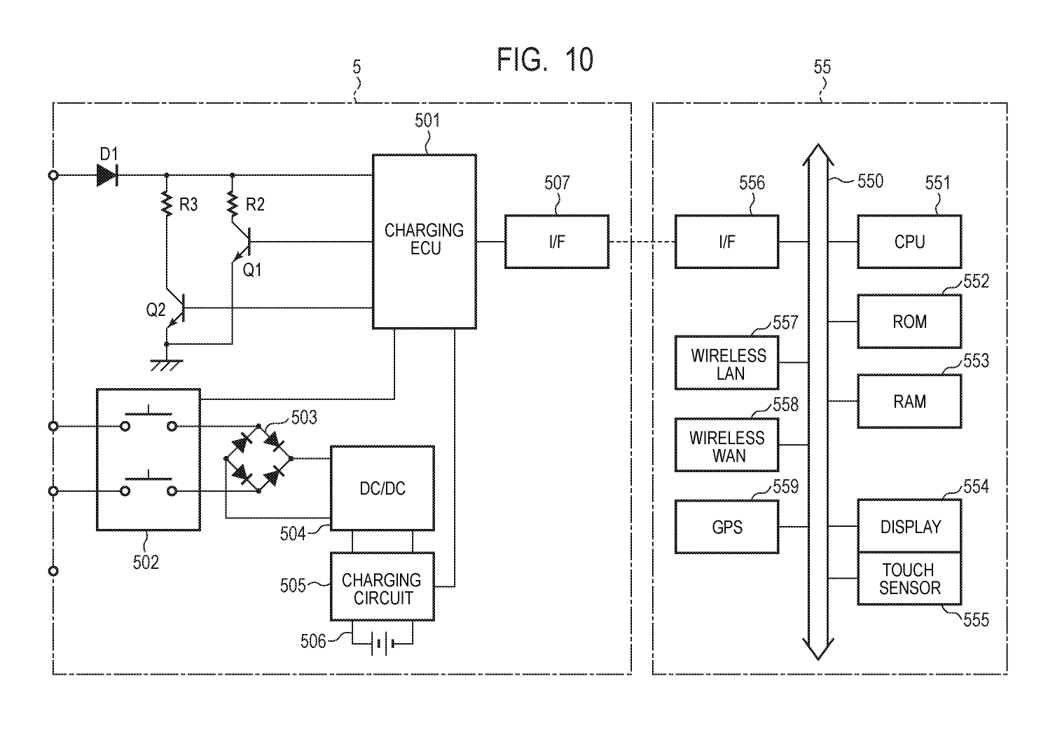

Next, a recharging system in a second example embodiment will be described. FIG. 10 is a block diagram of a charging circuit of the vehicle 5 and a mobile terminal in the present example embodiment. In the present example embodiment, wireless communication with the recharging controller 3 is performed by a mobile terminal 55 instead of the wireless ECU 510. The mobile terminal 55 may be formed of an information device such as a smartphone, a tablet computer, a car navigation system, or the like. The present example embodiment is not necessarily limited to the mobile terminal 55 separated from the vehicle 5 but may be an on-vehicle device having some of the plurality of ECUs of the vehicle 5 (the wireless ECU 510 of the first example embodiment). While the present example embodiment is applicable to an information device including a mobile terminal and an on-vehicle device, the mobile terminal 55 will now be described as an example. The mobile terminal 55 has a bus 550, a CPU 551, a ROM 552, a RAM 553, a display 554, a touch sensor 555, an I/F 556, a wireless LAN unit 557, a wireless WAN unit 558, and a Global Positioning System (GPS) unit 559. The bus 550 includes an address bus and a data bus and inputs and outputs data to and from circuits such as the CPU 551. The CPU 551 executes an operating program and an application program and performs control of the entire mobile terminal 55. The ROM 552 is formed of a nonvolatile memory and stores the operating program, the application program, or the like. The RAM 553 provides a memory region necessary for the operation of the CPU 551. The display 554 is a touchscreen on which the touch sensor 555 is arranged on the surface thereof. A number provided to the battery charger 4, a recharge level, a billing amount, or the like may be displayed on the display 554.

The wireless LAN unit 557 is a wireless transceiver unit based on the Wi-Fi standard, for example. The wireless WAN unit 558 is a transceiver unit capable of connecting to a wireless line for mobile phones such as 3G, LTE, 4G, or the like. The I/F 556 is a near-field wireless communication unit such as Bluetooth, for example, that is able to communicate with the charging ECU 501 of the vehicle 5. The I/F 556 functions as an input unit for information from the vehicle 5. Note that the wireless LAN unit 306 and the wireless WAN unit 307 may be used for communication with the vehicle 5. The GPS unit 559 is able to measure the position of the mobile terminal 55 by receiving electric waves from a plurality of GPS satellites. It is possible to detect whether or not the vehicle 5 enters a recharge service area based on the position measured by the GPS unit 559.

The charging ECU 501 and a peripheral circuit of the vehicle 5 are configured in the same manner as those of the first example embodiment. In the present example embodiment, however, the charging ECU 501 has the I/F 507 that can communicates with the mobile terminal 55. Note that the charging ECU 501 and the mobile terminal 55 may transmit and receive data through not only wireless communication but also wired communication.

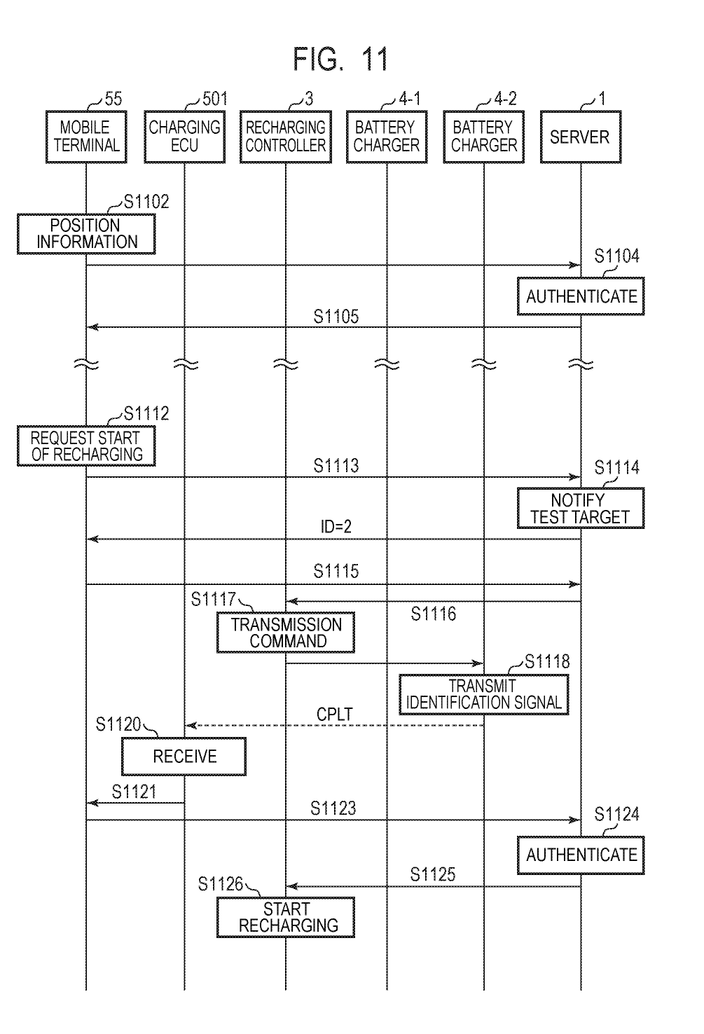

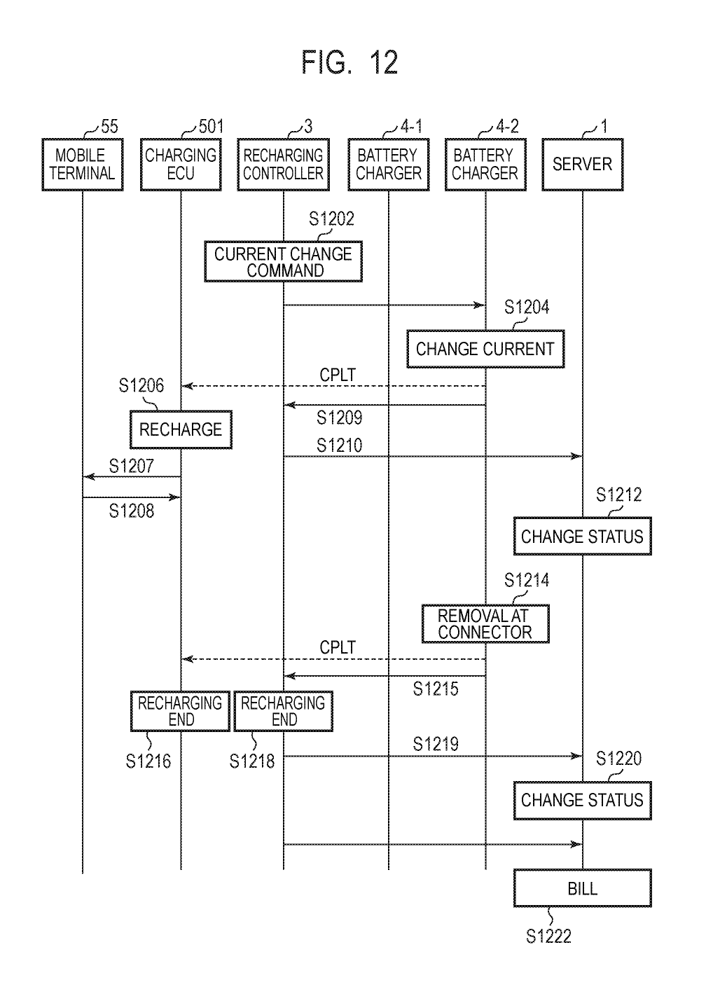

FIG. 11 and FIG. 12 are sequence charts of a recharging system in the present example embodiment. In the description below, it is assumed that the mobile terminal 55 does not communicate with the recharging controller 3 by the wireless LAN but with the server 1 via the public wireless line using the wireless WAN unit 307. Further, it is assumed that the user has completed user registration to the server 1 using the mobile terminal 55.

In FIG. 11, the user carrying the mobile terminal 55 drives the vehicle 5, and the mobile terminal 55 periodically transmits positional information obtained from the GPS unit 559 to the server 1 via the public wireless line (step S1102). Note that the mobile terminal 55 may pre-store the position of a facility acquired from the server 1 and transmit the position information to the server 1 when determining that the mobile terminal 55 has entered the facility, rather than the mobile terminal 55 periodically transmits the position information to the server 1. In response to detecting that the mobile terminal 55 has entered a parking lot based on the transmitted position information, the server 1 authenticates the user (step S1104) and transmits an authentication result to the mobile terminal 55 (step S1105). The mobile terminal 55 receives the authentication result and displays the authentication result on the display 554. The user stops the vehicle 5 in front of the battery charger 4-2 and connects the charging cable 4a to the vehicle 5. Since the process of connection confirmation between the battery charger 4-2 and the vehicle 5 is the same as the process of steps S710 to S714 in the first example embodiment, the description thereof will be omitted.

After the connection confirmation is performed, the mobile terminal 55 transmits a recharge start request to the server 1 (step S1112). In response to receiving the recharge start request, the recharging controller 3 sequentially transmits an identification signal to the plurality of battery chargers 4 connected to the vehicle 5. In the description below, it is assumed that different vehicles 5 are connected to the battery chargers 4-1 and 4-2, respectively, and a recharge start request is issued from the vehicle 5 connected to the battery charger 4-2. In response to receiving the recharge start request (step S1113), the server 1 notifies the mobile terminal 55 of the identification number of the battery charger 4 which is a test target out of the battery chargers 4 connected to the vehicles 5 (step S1114). In this example, since no reception notification of the identification signal is transmitted to the server 1 from the vehicle 5 connected to the battery charger 4-1, the test target is the battery charger 4-2. The server 1 transmits the identification number (ID=2) of the battery charger 4-2 to the mobile terminal 55 and, when receiving the identification number, the mobile terminal 55 notifies the server 1 of an acknowledgement (step S1115). The server 1 transmits the transmission command of an identification signal to the recharging controller 3 (step S1116), and the recharging controller 3 transmits a transmission command to the battery charger 4-2 (step S1117).

The battery charger 4-2 minimizes the duty ratio of the pilot signal CPLT and transmits a pilot signal CPLT indicating that the maximum transmittable current is zero to the charging ECU 501 (step S1118). The charging ECU 501 receives the pilot signal CPLT and detects the identification signal based on the duty ratio of the pilot signal CPLT (step S1120). In response to detecting the identification signal in the pilot signal CPLT, the charging ECU 501 notifies the wireless ECU 510 that the identification signal has been received (step S1121). Further, in response to receiving the identification signal, the charging ECU 501 turns on the transistor switch Q2 to reduce the voltage of the pilot signal CPLT from 9 V to 6 V. In response to detecting the voltage of the pilot signal CPLT, the battery charger 4-2 changes the battery charger status and waits for a recharge start command.

The mobile terminal 55 transmits, to the server 1, a response signal indicating that the identification signal has been received (step S1123). The response signal includes the user ID and the battery charger ID. The server 1 performs authentication of the user ID (step S1124) and transmits an authentication result to the recharging controller 3 (step S1125). When the authentication is successful, the recharging controller 3 determines that recharging with the battery charger 4-2 can be started (step S1126).

In FIG. 12, the recharging controller 3 transmits a current change command to the battery charger 4-2 (step S1202), and the battery charger 4-2 changes the maximum current from 0 A to 15 A, for example (step S1204). The maximum current is determined by the duty ratio of the pilot signal CPLT as described above. The charging ECU 501 detects the duty ratio of the pilot signal CPLT and starts recharging at the predetermined maximum current (step S1206). That is, the charging ECU 501 turns on the relay switch 502 and charges the battery 506 with the current supplied from the battery charger 4-2 (step S1206). The charging ECU 501 notifies the mobile terminal 55 that recharging is ongoing (step S1207), the mobile terminal 55 sends back confirmation of notification (step S1208).

The battery charger 4-2 notifies the recharging controller 3 that the maximum current has changed to 15 A (step S1209), and the recharging controller 3 notifies the server 1 that the recharging at the maximum current of 15 A has started at the battery charger 4-2 (step S1210). The server 1 records the start of recharging as a status (step S1212).

Upon the completion of recharging in the vehicle 5, the user removes the charging cable 4a from the vehicle 5 (step S1214). In the vehicle 5, the pilot signal CPLT becomes a low level, and the charging ECU 501 ends the recharging (step S1216). In the battery charger 4-2, the pilot signal CPLT becomes 12 V. In response to detecting the removal of the charging cable 4a, the battery charger 4-2 notifies the recharging controller 3 of the end of recharging (step S1215). The recharging controller 3 receives the end of recharging at the battery charger 4-2 (step S1218) and transmits a notification of the end of recharging together with the identification number (ID=2) of the battery charger 4-2 to the server 1 (step S1219). The server 1 changes the status of the user from “charging” to “charged” (step S1220). Furthermore, the recharging controller 3 transmits the user ID, the identification number of the battery charger 4-2, and recharging time period to the server 1 as billing information, and the server 1 performs a billing process on the user account (step S1222).

Also in the present example embodiment, it is possible to automatically detect which of the battery chargers 4 the authenticated vehicle 5 is connected to and start recharging using the mobile terminal 55. Further, the same effect and advantage can be obtained with a use of a public wireless line instead of a wireless LAN. While the recharging system in the present example embodiment uses GPS position information to automatically detect that the vehicle 5 has entered a parking lot, position information may be acquired based on an access point of a wireless LAN. That is, the position information on the mobile terminal 55 may be acquired by using a position information database associated with an SSID. For example, when the battery charger 4 is installed in an underground facility and the GPS wave cannot be received, acquisition of position information by using the SSID of a wireless LAN is particularly effective. Furthermore, the user may manually notify the recharging system. For example, when the vehicle 5 has entered a parking lot, the user may cause the mobile terminal 55 or the recharging controller 3 to read a card in which the user ID is stored and input the user ID.

Note that, while the mobile terminal 55 communicates with the server 1 in the present example embodiment, the mobile terminal 55 may communicate with the recharging controller 3 by a wireless LAN in a similar manner to the first example embodiment.

### Third Example Embodiment

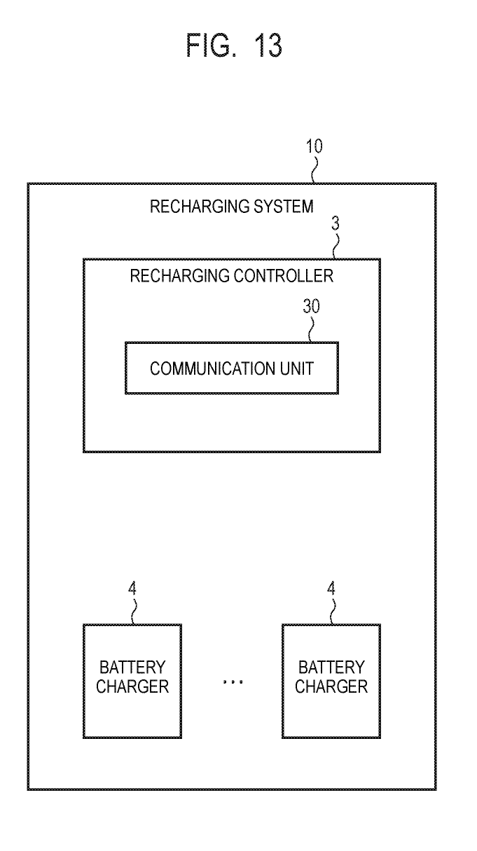

FIG. 13 is a schematic configuration diagram of a recharging system 10 according to each example embodiment described above. The recharging system 10 has the recharging controller 3 and a plurality of the battery chargers 4. Each of the battery chargers 4 is capable of charging a battery of a vehicle through a charging cable or in a contactless manner and is capable of transmitting a signal that instructs the vehicle to start recharging. The recharging controller 3 has a communication unit 30 capable of communicating with the vehicle wirelessly or via a wire. The recharging controller 3 sequentially outputs identification signals indicating an instruction other than an instruction of the start of recharging from each of the plurality of battery chargers 4. When receiving a response signal from the vehicle responding to the identification signal via the communication unit 30, the recharging controller 3 allows the vehicle which has transmitted the response signal to perform recharging. According to such a configuration, it is possible to automatically detect which battery charger the vehicle is connected to without changing the conventional recharge standard. Recharging can be automatically started in response to connection of the charging cable, and thus the function of so-called plug-and-charge can be realized.

The recharging controller 3 in the present example embodiment may include the function of the server 1 in the first and second example embodiments. That is, the recharging controller 3 is not required to be a single device and may include another device (for example, a server) connected by a network.

### Other Example Embodiments

The present invention is not limited to the example embodiments described above and can be changed as appropriate within a scope not departing from the spirit of the present invention. For example, while data communication with the vehicle is performed using wireless communication such as a wireless LAN, a wireless WAN, or the like in the first and second example embodiments, wired communication such as power line communication (PLC) may be used. That is, data may be superimposed on the power source lines L2 and L3 of the charging cable 4a to perform authentication. Furthermore, while a recharging system using the charging cable 4a has been described as an example in the first and second example embodiments, the present invention is also applicable to a contactless recharging system using no charging cable. When an authentication process is unavailable in the contactless recharging system, authentication can be performed by using data communication through a wireless LAN, a wireless WAN, PLC, or the like. Further, while a process such as authentication of a user ID, billing, or the like is performed by the server 1 in the first and second example embodiments, the process performed by the server 1 may be performed in the recharging controller 3. That is, a part or whole of the function of the server 1 may be performed in the recharging controller 3. Further, in the first and second example embodiments, a part or whole of the function of the recharging controller 3 may be performed in the server 1.

In the first example embodiment, a part or whole of the function of one of the charging ECU 501 and the wireless ECU 510 may be performed in the other. Furthermore, in the second example embodiment, a part or whole of the function of one of the charging ECU 501 and the mobile terminal 55 may be performed in the other. The mobile terminal 55 may not necessarily be required to be carried by the user but may be fixed to the vehicle 5.

The application program responsible for the operation of the server 1, the recharging controller 3, the battery charger 4, or the mobile terminal 55 may be created in any format as long as it is in a form executable by a computer. The application program may be provided by a storage medium such as an optical disk, a magnetic disk, a flash memory, a hard disk, or the like or may be provided through a telecommunication line such as the Internet.

The whole or part of the example embodiments disclosed above can be described as, but not limited to, the following supplementary notes.

(Supplementary Note 1)

A recharging system comprising:

a plurality of battery chargers each of which is capable of charging a battery of a vehicle and transmitting a control signal that instructs the vehicle to start recharging; and

a recharging controller that controls the plurality of battery chargers,

wherein the recharging controller

comprises a communication unit capable of communicating with the vehicle,

sequentially outputs identification signals indicating instruction other than start of recharging from the plurality of battery chargers, respectively, and

when receiving a response signal from the vehicle responding to the identification signals via the communication unit, allows the vehicle which has transmitted the response signal to perform recharging.

(Supplementary Note 2)

The recharging system according to supplementary note 1, wherein the recharging controller authenticates the vehicle when communication between the vehicle which has been registered in advance and the communication unit is established and sequentially outputs the identification signals from the plurality of battery chargers each connected to the authenticated vehicle, respectively.

(Supplementary Note 3)

The recharging system according to supplementary note 1 or 2, wherein the control signal is able to instruct the vehicle for a maximum transmittable current, and each of the identification signals indicates that the maximum current is zero.

(Supplementary Note 4)

The recharging system according to Supplementary note 1 or 2, wherein each of the identification signals indicates a suspension state of charging.

(Supplementary Note 5)

The recharging system according to any one of supplementary notes 1 to 4 further comprising a server that registers in advance a user of the vehicle, wherein the server authenticates user information transmitted from the vehicle via the recharging controller and instructs the recharging controller to start recharging the vehicle.

(Supplementary Note 6)

The recharging system according to any one of supplementary notes 1 to 5, wherein the battery of the vehicle can be charged via a charging cable, and the control signal can be transmitted via a control signal line included in the charging cable.

(Supplementary Note 7)

The recharging system according to any one of supplementary notes 1 to 6, wherein the communication unit performs wireless communication.

(Supplementary Note 8)

A recharging controller that controls a plurality of battery chargers each of which is capable of charging a battery of a vehicle and transmitting a control signal that instructs the vehicle to start recharging,

wherein the recharging controller

comprises a communication unit capable of communicating with the vehicle,

sequentially outputs identification signals indicating instruction other than start of recharging from the plurality of battery chargers, respectively, and

when receiving a response signal from the vehicle responding to the identification signals via the communication unit, allows the vehicle which has transmitted the response signal to perform recharging.

(Supplementary Note 9)

The recharging controller according to supplementary note 8, wherein the recharging controller authenticates the vehicle when communication between the vehicle which has been registered in advance and the communication unit is established and sequentially outputs the identification signals from the plurality of battery chargers each connected to the authenticated vehicle, respectively.

(Supplementary Note 10)

The recharging controller according to supplementary note 8 or 9, wherein the control signal is able to instruct the vehicle for a maximum transmittable current, and each of the identification signals indicates that the maximum current is zero.

(Supplementary Note 11)

The recharging controller according to supplementary note 8 or 9, wherein each of the identification signals indicates a suspension state of charging.

(Supplementary Note 12)

The recharging controller according to any one of supplementary notes 8 to 11 further comprising a server that registers in advance a user of the vehicle, wherein the server authenticates user information transmitted from the vehicle via the recharging controller and instructs the recharging controller to start recharging the vehicle.

(Supplementary Note 13)

The recharging controller according to any one of supplementary notes 8 to 12, wherein the battery of the vehicle can be charged via a charging cable, and the control signal can be transmitted via a control signal line included in the charging cable.

(Supplementary Note 14)

The recharging controller according to any one of Supplementary notes 8 to 13, wherein the communication unit performs wireless communication.

(Supplementary Note 15)

A battery charger that is capable of charging a battery of a vehicle and transmitting a control signal that instructs the vehicle to start recharging,

wherein the battery charger sequentially outputs an identification signal indicating instruction other than start of recharging by being controlled by a recharging controller comprising a communication unit capable of communicating with the vehicle, and

wherein when the recharging controller receives a response signal from the vehicle responding to the identification signal via the communication unit, allows the vehicle which has transmitted the response signal to perform recharging.

(Supplementary Note 16)

The battery charger according to supplementary note 15, wherein the recharging controller authenticates the vehicle when communication between the vehicle which has been registered in advance and the communication unit is established and sequentially outputs the identification signal from a plurality of battery chargers each connected to the authenticated vehicle, respectively.

(Supplementary Note 17)

The battery charger according to supplementary note 15 or 16, wherein the control signal is able to instruct the vehicle for a maximum transmittable current, and the identification signal indicates that the maximum current is zero.

(Supplementary Note 18)

The battery charger according to supplementary note 15 or 16, wherein the identification signal indicates a suspension state of charging.

(Supplementary Note 19)

The battery charger according to any one of supplementary notes 15 to 18 further comprising a server that registers in advance a user of the vehicle, wherein the server authenticates user information transmitted from the vehicle via the recharging controller and instructs the recharging controller to start recharging the vehicle.

(Supplementary Note 20)

The battery charger according to any one of supplementary notes 15 to 19, wherein the battery of the vehicle can be charged via a charging cable, and the control signal can be transmitted via a control signal line included in the charging cable.

(Supplementary Note 21)

The battery charger according to any one of supplementary notes 15 to 20, wherein the communication unit performs wireless communication.

(Supplementary Note 22)

An information device used in a recharging system comprising a plurality of battery chargers each of which is capable of charging a battery of a vehicle and transmitting a control signal that instructs the vehicle to start recharging and a recharging controller that controls the plurality of battery chargers, the information device comprising:

an input unit that receives from the vehicle a notification that an identification signal indicating an instruction other than start of recharging is output; and

a communication unit that transmits a response signal to the identification signal to the recharging controller,

wherein when the recharging controller receives the response signal, the input unit receives a notification that the vehicle which has transmitted the response signal is allowed to perform recharging.

(Supplementary Note 23)

The information device according to supplementary note 22, wherein the recharging controller authenticates the vehicle when communication between the vehicle which has been registered in advance and the communication unit is established and sequentially outputs the identification signal from the plurality of battery chargers each connected to the authenticated vehicle, respectively.

(Supplementary Note 24)

The information device according to supplementary note 22 or 23, wherein the control signal is able to instruct the vehicle for a maximum transmittable current, and the identification signal indicates that the maximum current is zero.

(Supplementary Note 25)

The information device according to supplementary note 22 or 23, wherein the identification signal indicates a suspension state of charging.

(Supplementary Note 26)

The information device according to any one of supplementary notes 22 to 25 further comprising a server that registers in advance a user of the vehicle, wherein the server authenticates user information transmitted from the vehicle via the recharging controller and instructs the recharging controller to start recharging the vehicle.

(Supplementary Note 27)

The information device according to any one of supplementary notes 22 to 26, wherein the battery of the vehicle can be charged via a charging cable, and the control signal can be transmitted via a control signal line included in the charging cable.

(Supplementary Note 28)

The information device according to any one of supplementary notes 22 to 27, wherein the communication unit performs wireless communication.

(Supplementary Note 29)

The information device according to any one of supplementary notes 22 to 27, wherein the information device is an on-vehicle device mounted on the vehicle.

(Supplementary Note 30)

The information device according to any one of supplementary notes 22 to 27, wherein the information device is a mobile terminal separated from the vehicle.

(Supplementary Note 31)

A recharging method for a recharging system comprising a plurality of battery chargers each of which is capable of charging a battery of a vehicle and transmitting a control signal that instructs the vehicle to start recharging and a recharging controller that controls the plurality of battery chargers, the recharging method comprising steps of:

sequentially outputting identification signals indicating instruction other than start of recharging from the plurality of battery chargers, respectively; and

when the recharging controller receives a response signal from the vehicle responding to the identification signals via a communication unit, allowing the vehicle which has transmitted the response signal to perform recharging.

(Supplementary Note 32)

The recharging method according to supplementary note 31, wherein the recharging controller authenticates the vehicle when communication between the vehicle which has been registered in advance and the communication unit is established and sequentially outputs the identification signals from the plurality of battery chargers each connected to the authenticated vehicle, respectively.

(Supplementary Note 33)

The recharging method according to supplementary note 31 or 32, wherein the control signal is able to instruct the vehicle for a maximum transmittable current, and each of the identification signals indicates that the maximum current is zero.

(Supplementary Note 34)

The recharging method according to supplementary note 31 or 32, wherein each of the identification signals indicates a suspension state of charging.

(Supplementary Note 35)

The recharging method according to any one of supplementary notes 31 to 34, wherein a server that registers in advance a user of the vehicle is further provided, wherein the server authenticates user information transmitted from the vehicle via the recharging controller and instructs the recharging controller to start recharging the vehicle.

(Supplementary Note 36)

The recharging method according to any one of supplementary notes 31 to 35, wherein the battery of the vehicle can be charged via a charging cable, and the control signal can be transmitted via a control signal line included in the charging cable.

(Supplementary Note 37)

The recharging method according to any one of supplementary notes 31 to 36, wherein the communication unit performs wireless communication.

(Supplementary Note 38)

A storage medium storing a program that causes a computer to execute a recharging method for a recharging system comprising a plurality of battery chargers each of which is capable of charging a battery of a vehicle and transmitting a control signal that instructs the vehicle to start recharging and a recharging controller that controls the plurality of battery chargers, the recharging method comprising steps of:

sequentially outputting identification signals indicating instruction other than start of recharging from the plurality of battery chargers, respectively; and

when the recharging controller receives a response signal from the vehicle responding to the identification signals via a communication unit, allowing the vehicle which has transmitted the response signal to perform recharging.

(Supplementary Note 39)

The storage medium according to supplementary note 38, wherein the recharging controller authenticates the vehicle when communication between the vehicle which has been registered in advance and the communication unit is established and sequentially outputs the identification signals from the plurality of battery chargers each connected to the authenticated vehicle, respectively.

(Supplementary Note 40)

The storage medium according to supplementary note 38 or 39, wherein the control signal is able to instruct the vehicle for a maximum transmittable current, and each of the identification signals indicates that the maximum current is zero.

(Supplementary Note 41)

The storage medium according to supplementary note 38 or 39, wherein each of the identification signals indicates a suspension state of charging.

(Supplementary Note 42) The storage medium according to any one of supplementary notes 38 to 41, wherein a server that registers in advance a user of the vehicle is further provided, wherein the server authenticates user information transmitted from the vehicle via the recharging controller and instructs the recharging controller to start recharging the vehicle.

(Supplementary Note 43)

The storage medium according to any one of supplementary notes 38 to 42, wherein the battery of the vehicle can be charged via a charging cable, and the control signal can be transmitted via a control signal line included in the charging cable.

(Supplementary Note 44)

The storage medium according to any one of supplementary notes 38 to 43, wherein the communication unit performs wireless communication.

This application is based upon and claims the benefit of priority from Japanese Patent Application No. 2016-194473, filed on Sep. 30, 2016, the disclosure of which is incorporated herein in its entirety by reference.

What is claimed is:

1. A recharging controller including a communication unit that is capable of wirelessly communicating with a vehicle,
wherein the recharging controller
authenticates the vehicle when wireless communication between the vehicle and the communication unit is established,
when a recharge start request is received from the authenticated vehicle, outputs an identification signal, which indicates an instruction other than start of recharging, to each of a plurality of battery chargers to be controlled, and
when a response signal to the identification signal is received from the authenticated vehicle via the communication unit, determines that recharging at one of the battery chargers to which the authenticated vehicle is connected can be started.

2. The recharging controller according to claim 1, wherein the recharging controller
sequentially outputs the identification signal to the plurality of battery chargers, respectively,
when the response signal is not received within a predetermined time period, transmits the identification signal to a next battery charger, and
when the response signal is received within a predetermined time period, determines that recharging at a battery charger to which the identification signal has been output can be started.

3. The recharging controller according to claim 1,
wherein the response signal includes identification information on the battery charger to which the authenticated vehicle is connected, and
wherein the recharging controller determines that recharging at a battery charger corresponding to the identification information can be started.

4. A recharging system comprising the recharging controller according to claim 1; and a server that registers in advance a user of the vehicle, wherein the server authenticates user information transmitted from the vehicle via the recharging controller and instructs the recharging controller to start recharging the vehicle.

5. The recharging system according to claim 4, wherein, based on the instruction from the server, the recharging controller determines that recharging at the battery charger to which the authenticated vehicle is connected can be started.

6.-8. (canceled)

9. A recharging method in a recharging controller comprising a communication unit that is capable of wirelessly communicating with a vehicle, the recharging method comprising:
authenticating the vehicle when wireless communication between the vehicle and the communication unit is established,
when a recharge start request is received from the authenticated vehicle, outputting an identification signal, which indicates an instruction other than start of recharging, to each of a plurality of battery chargers to be controlled, and
when a response signal to the identification signal is received from the authenticated vehicle via the communication unit, determining that recharging at one of the battery chargers to which the authenticated vehicle is connected can be started.

10. The recharging method according to claim 9 further comprising:
sequentially outputting the identification signal to the plurality of battery chargers, respectively,
when the response signal is not received within a predetermined time period, transmitting the identification signal to a next battery charger, and
when the response signal is received within a predetermined time period, determining that recharging at a battery charger to which the identification signal has been output can be started.

11. The recharging method according to claim 9,
wherein the response signal includes identification information on the battery charger to which the authenticated vehicle is connected, and
the recharging method further comprising determining that recharging at a battery charger corresponding to the identification information can be started.

12. A non-transitory storage medium storing a program that causes a computer to execute a recharging method in a recharging controller comprising a communication unit that is capable of wirelessly communicating with a vehicle, wherein the program is configured to:
authenticate the vehicle when wireless communication between the vehicle and the communication unit is established,
when a recharge start request is received from the authenticated vehicle, output an identification signal, which indicates an instruction other than start of recharging, to each of a plurality of battery chargers to be controlled, and
when a response signal to the identification signal is received from the authenticated vehicle via the communication unit, determine that recharging at one of the battery chargers to which the authenticated vehicle is connected can be started.

13. A non-transitory storage medium according to claim 12, wherein the program is configured to:
sequentially output the identification signal to the plurality of battery chargers, respectively,
when the response signal is not received within a predetermined time period, transmit the identification signal to a next battery charger, and
when the response signal is received within a predetermined time period, determine that recharging at a battery charger to which the identification signal has been output can be started.

14. The non-transitory storage medium according to claim 12,
wherein the response signal includes identification information on the battery charger to which the authenticated vehicle is connected, and
wherein the program is configured to determine that recharging at a battery charger corresponding to the identification information can be started.
